(19) United States
(12) Patent Application Publication
(10) Pub. No.: US 2007/0093925 A1
(43) Pub. Date: Apr. 26, 2007

(54) Processes for improving production of a work machine

(76) Inventor: Eric Alan Moughler, Metamora, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/254,811

(22) Filed: Oct. 21, 2005

(51) Int. Cl. G06F 19/00

(52) U.S. Cl. 700/108; 702/182

(57) ABSTRACT

Systems and methods are disclosed for improving production of a work machine. According to one embodiment, a system for improving the production of a work machine is disclosed. The system includes a data collector disposed within the work machine and configured to collect operation data associated with the work machine and transmit the collected data over a communication network. The system also includes a production management system, coupled to the communication network and configured to receive the operation data from the data collector, analyze the received operation data based on one or more predefined specifications, and adjust a production aspect of the work machine if the received operation data does not conform to the one or more predefined specifications. The system further includes a production entity, associated with the work machine and in communication with the production management system, configured to receive the analyzed operation data from the production management system.

### TECHNICAL FIELD

This application relates generally to the production of industrial equipment and, more particularly, to a system and method for improving production of a work machine.

### BACKGROUND

New product developments for work machines and other types of heavy machinery typically undergo extensive field testing prior to mass production and release to the marketplace. This testing may ensure that the work machine meets certain benchmark performance specifications under actual operating conditions. Failure to meet these specifications may result in reduced reliability of the work machine, potentially resulting in premature equipment failure that may lead to costly repair or replacement of the work machine and/or its constituent components. In addition to repair costs, operational delays associated with the failure of unreliable work machine components substantially reduce equipment productivity.

During the product test phase, test engineers are typically deployed to field testing sites to continuously monitor the performance of a work machine. This may include tracking status conditions associated with the machine and collecting operation parameters from electronic modules within the work machine for further analysis. This analysis may lead to the redesign of a machine component. As a result, subsequent field testing sessions must be performed. In addition to delaying the production of the work machine, each design and test iteration may require extensive and costly dedication of personnel time and resources, ultimately increasing the costs associated with release of a new product. Therefore, time efficient testing and design of new work machines may be of significant importance to reducing costs associated with work machine development.

One attempt to eliminate on-site testing and data acquisition is described in U.S. Patent Application Publication No. 2003/0069648 to Douglas et al (“the '648 publication”). The '648 publication describes a system and method for remotely monitoring and managing equipment. The system of the '648 publication includes a mobile piece of equipment, a fixed piece of equipment, a central processing system, and one or more means for communicating data between the equipment and the processing system. The '648 publication also discloses a remote operation system for remotely operating the equipment based on the communicated data. The system of the '648 publication further provides a user interface enabling the user to access the central processing system to access certain data obtained from the equipment.

Although the system of the '648 publication may increase the efficiency associated with on-site monitoring and data gathering of a machine system, it lacks a mechanism to control the manufacturing, design, or production based on the monitored machine data. As a result of the lack of “real-time” data integration into production processes, manufacturing and production may still suffer the same efficiency problems experienced by other conventional systems, as design engineers must manually improve each component based on monitored operational data.

Furthermore, because the system of the '648 publication is only configured to track, monitor, and control an operation of the work machine, it may not have the ability to identify the design and production modifications made during different phases of design and production. As a result, should monitored data indicate a deficiency in a particular design iteration, the system may not recognize whether that deficiency has been accounted for in a later design session. Thus, for newly developed machines in different phases of testing, the data collected by the system of the '648 publication may not be accurately identified or tracked.

The disclosed system and method for improving production of a work machine are directed towards overcoming one or more of the problems set forth above.

### SUMMARY OF THE INVENTION

Systems and methods are disclosed for improving production of a work machine. According to one embodiment, a system for improving the production of a work machine is disclosed. The system may include a data collector disposed within the work machine and configured to collect operation data associated with the work machine and transmit the collected data over a communication network. The system may also include a production management system, coupled to the communication network and configured to receive the operation data from the data collector, analyze the received operation data based on one or more predefined specifications, and adjust a production aspect of the work machine if the received operation data does not conform to the one or more predefined specifications. The system may further include a production entity, associated with the work machine and in communication with the production management system, configured to receive the analyzed operation data from the production management system.

In another embodiment, a method for improving the production of a work machine is disclosed. The method may include receiving, in a production management system, operation data associated with a first operation of the work machine during operation of the work machine. The method may also include analyzing the received operation data based on one or more predefined specifications. The method may further include adjusting a production aspect of the work machine if the received operation data does not conform to the one or more predefined specifications. The method may also include providing the adjusted production aspect to a production facility that manufactures at least one of the work machine and a component of the work machine.

In yet another embodiment, the present disclosure is directed toward a production environment including a first work machine performing operations in a first work machine environment and a production management system configured to receive operation data from the first work machine. The production management system may include a computer-readable medium configured to store predefined specifications. The production management system may also include a processor that, when executing program code on a memory device, is configured to receive operation data associated with the operation of the first work machine and modify a production aspect of the first work machine if a portion of the operation data does not conform to the predefined design specification.

### BRIEF DESCRIPTION OF THE DRAWINGS

FIG. 1 illustrates an exemplary disclosed production environment consistent with certain disclosed embodiments;

FIG. 1A provides a schematic illustration of an exemplary disclosed system for improving the production of a work machine in accordance with certain disclosed embodiments;

FIG. 2 illustrates a flowchart depicting an exemplary disclosed method for adjusting a production aspect of a work machine in accordance with certain disclosed embodiments; and

FIG. 3 illustrates a flowchart depicting an exemplary disclosed method for improving the production of a work machine according to certain disclosed embodiments.

### DETAILED DESCRIPTION

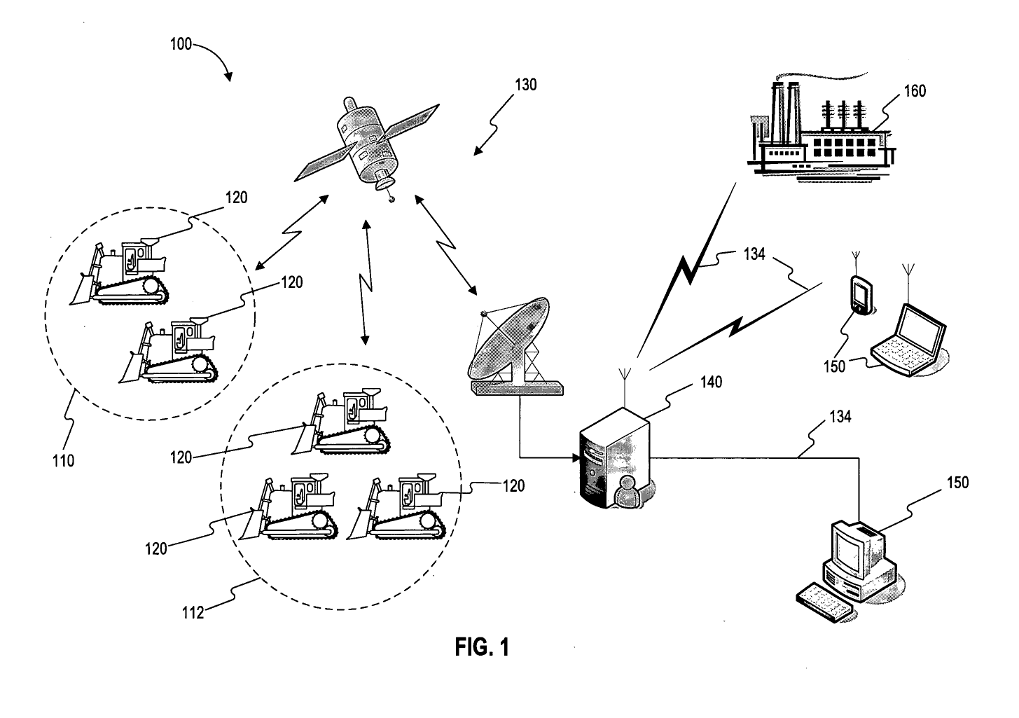

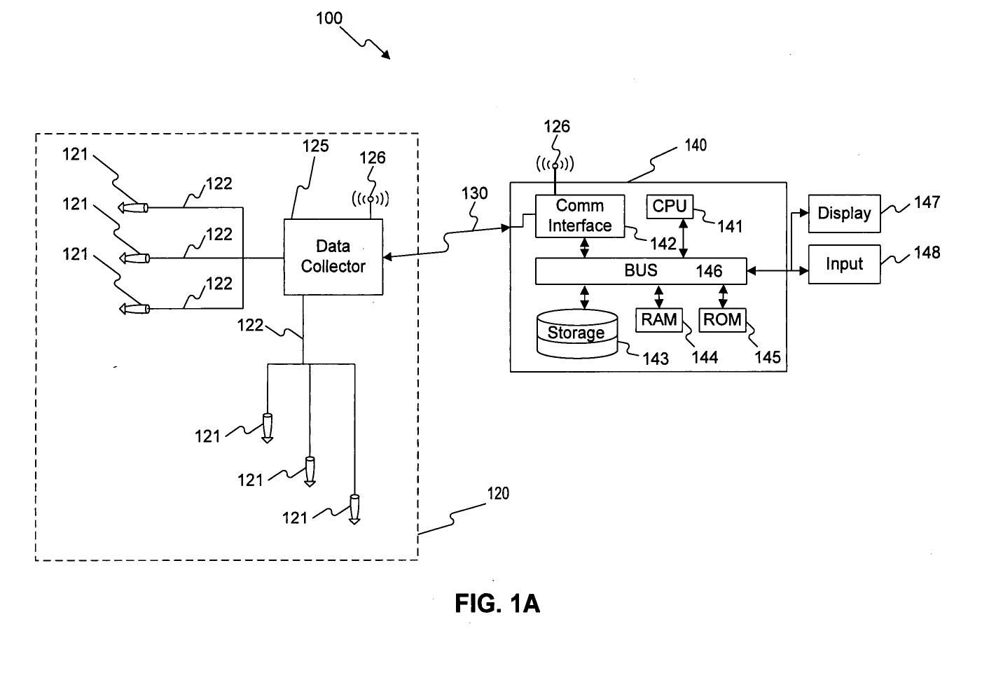

FIG. 1 illustrates an exemplary production environment 100 consistent with certain disclosed embodiments. Production environment 100 may include components that perform individual tasks that contribute to a work machine environment task, such as mining, construction, transportation, agriculture, manufacturing, or any other type of task associated with other types of industries. For example, production environment 100 may include one or more work machines 120 coupled to an production management system 140 via a communication network 130. The production environment 100 may be configured to monitor, collect, and filter information associated with a test operation of one or more work machines 120 and distribute the information to one or more back-end systems, such as production management system 140, production entity 150, and/or production facility 160. It is contemplated that additional and/or different components than those listed above may be included in production environment 100.

Work machines 120 may each be a fixed or mobile machine configured to perform an operation associated with production environment 100. Thus, work machine, as the term is used herein, refers to a fixed or mobile machine that performs some type of operation associated with a particular industry, such as mining, construction, farming, etc. and operates between or within work environments (e.g., construction site, mine site, power plants, etc.) A non-limiting example of a fixed machine includes an engine system operating in a plant or off-shore environment (e.g., off-shore drilling platform). Non-limiting examples of mobile machines include commercial machines, such as trucks, cranes, earth moving vehicles, mining vehicles, backhoes, material handling equipment, farming equipment, marine vessels, aircraft, and any type of movable machine that operates in a work environment. A work machine may be driven by a combustion engine or an electric motor. The types of work machines listed above are exemplary and not intended to be limiting. It is contemplated that production environment 100 may implement any type of work machine. Accordingly, although FIG. 1 shows work machines 120 as track-type tractor machines, each work machine 120 may be any type of work machine operable to perform a particular function within production environment 100. Furthermore, it is contemplated that work machines 120 may include a first set of work machines 110 and a second set of work machines 112 for monitoring the operation of groups of work machine.

In one embodiment, each work machine 120 may include on-board data collection and communication equipment to monitor, collect, and/or transmit information associated with an operation of one or more components of work machine 120. As shown in FIG. 1A, work machine 120 may include, among other things, one or more monitoring devices 121, such as sensors, electronic control modules, etc. (not shown) coupled to one or more data collection devices 125 via communication lines 122, one or more transceiver devices 126, and/or any other such components for monitoring, collecting, and communicating information associated with the operation of work machine 120. Each work machine 120 may also be configured to receive information from off-board systems, such as a production management system 140, a production entity 150, a back-end communication system (not shown), etc. The components described above are exemplary and not intended to be limiting. Accordingly, the disclosed embodiments contemplate each work machine 120 including additional and/or different components than those listed above.

Communication network 130 may be a network that provides two-way communication between each work machine 120 and an off-board system, such as production management system 140. For example, communication network 130 may communicatively couple work machines 120 to production management system 140 across a wireless networking platform such as, for example, a satellite communication system. Alternatively and/or additionally, communication network 130 may include one or more broadband communication platforms appropriate for communicatively coupling one or more work machines 120 to production management system 140 such as, for example, cellular, Bluetooth, microwave, point-to-point wireless, point-to-multipoint wireless, multipoint-to-multipoint wireless, or any other appropriate communication platform for networking a number of components. Although communication network 130 is illustrated as a satellite wireless communication network, it is contemplated that communication network 130 may include wireline networks such as, for example, Ethernet, fiber optic, waveguide, or any other type of wired communication network.

Production management system 140 may be a system configured to receive, analyze, and distribute operational information from one or more work machines 120 via communication network 130. Operational information may include data reflecting one or more parameters associated with the operation of a respective work machine 120, such as, for example, status data (e.g., engine on/off, parked, stationary, etc.), load weight, engine speed, engine temperature, oil pressure, location, engine hours, tire wear, component fatigue, fluid levels, pressure data, work machine position information, and any other parameter associated with the operation of a work machine.

Production management system 140 may also communicate with other systems (e.g., production entity 150 and production facility 160) via communication links 134. For example, communication link 134 may include one or more data links that directly connect production management system 140 to another system (e.g., production entity 150) as part of a point-to-point or point-to-multipoint network. Alternatively and/or additionally, communication link 134 may be include a common access communication platform, such as the Internet, a private intranet, a corporate workgroup, or any other communication platform. Communication link 134 may include electrical wires, twisted pair cables, optical fiber cables, wireless links (e.g., infrared links, Bluetooth connections, satellite communication links, etc.), or any other media appropriate for transmitting data. Further, communication link 134 may be configured with hardware and/or software components that enable data to be transmitted using an analog format, a digital format, a combination thereof, or any other form of data communication.

Production entity 150 may include a computer system that is configured to receive data from production management system 140 in a manner consistent with the disclosed embodiments. For example, production entity 150 may include one or more computer terminals. Alternatively and/or additionally, production entity 150 may include personal data assistant systems (PDA), wireless communication devices (e.g., pagers, phones, etc.), notebook computers, diagnostic computer systems, data analyzers, or any other such computing devices configured to receive and process information, such as operation data. In one embodiment, production entity 150 may be associated with one or more sections of a business entity associated with the production and manufacturing of work machine 120. For instance, production entity 150 may be associated with a particular division of a business entity associated with production environment 100, such as, production and manufacturing, engineering and design, sales and marketing, procurement, research and development, supply chain management, and/or any other type of business entity that may be associated with production environment 100. In one embodiment, production entity 150 may be associated with a business entity that is affiliated with one or more sets of work machines 120, such as first set 110. Alternatively, different production entities may be associated with different business entities and/or work machines 120. Accordingly, the above descriptions are exemplary and not intended to be limiting. The disclosed embodiments contemplate any correlation (or none at all) between one or more business entities, and/or sections thereof, and the components of production environment 100.

Production entity 150 may be configured to communicate with production management system 140. Thus, production entity 150 may request operational data from production management system 140. In one embodiment, production entity 150 may receive the operational data in response to the request and analyze the received data according to the needs of the particular business entity associated with the respective production entity. For example, production entity 150 may be associated with an engineering division responsible for the design, research, and development of work machine 120 and its constituent components. Thus, production entity 150 may receive operational data from production management system 140 associated with particular components of a particular work machine 120 or a set of work machines 110. In this example, production entity 150 may be configured to analyze the received operational data to determine what, if any, action needs to be taken on a particular work machine 120 or component of work machine 120 (e.g., re-design, re-testing, further development, etc.) Production entity 150 may subsequently enter a request for modification of a production aspect of work machine 120 in response to the operational data received from production management system 140. For the purposes of the present disclosure, a production aspect may include one or more characteristics associated with the manufacturing of a work machine such as, for example, a production schedule, a product release date, a production rate, a production budget, or any other such characteristics associated with work machine manufacturing. For example, a production aspect may include one or more of a production schedule, a production timeline, a product release date, a production rate (e.g., units/day, units/month etc.), a production status (e.g., standby for redesign, halt, low (production of test models only), high (mass-production), etc.), or any other such aspect associated with the production and/or manufacturing of work machine 120. Alternatively and/or additionally, a production aspect may include one or more specifications associated with the manufacturing of work machine components such as, dimension, weight, size, material, stress/strain specifications, software settings, parameter ranges, or any other such specification to which a work machine component is designed. Moreover, the specifications may be associated with a particular component of work machine 120 such as, for example, a crossbar assembly, a temperature sensor, a motor, an electronic control unit (ECU), a transmission, or any other such component that may be manufactured according to particular specifications.

Production entity 150 may be configured to transmit results of any analysis to production management system 140 and/or production facility 160. For instance, following the above example, production entity 150 may transmit analysis information to production management system 140 for storage in a memory device. Production management system 140 and/or production entity 150, may subsequently access and analyze the information during future test operations of work machine 120.

Production facility 160 may include one or more production and manufacturing resources for the physical manufacturing and production of work machine 120. In one embodiment, production facility 160 may include assembly line equipment, hardware and software components, production management equipment, and/or other type of physical manufacturing resources associated with production environment 100.

Production facility 160 may be configured to modify the production of one or more work machines 120 or components thereof in response to a request from production management system 140 and/or production entity 150. For instance, production facility 160 may receive a request from production management system 140 to adjust the production of a component of work machine 120 according to a revised production schedule. Production facility 160 may also receive component modification data specifying changes in manufacturing and production specifications of the work machine to be implemented by production facility. Production facility 160 may make the appropriate modification to the manufacturing and production process in response to the received request.

In one embodiment, production management system 140 may include hardware and/or software components that perform processes consistent with certain disclosed embodiments. For example, as illustrated in FIG. 1A, production management system 140 may include one or more transceiver devices 126, a central processor unit (CPU) 141, a communication interface 142, one or more computer-readable memory devices, including storage device 143, a random access memory (RAM) module 144, and a read-only memory (ROM) module 145, a display unit 147, and/or an input device 148. The components described above are exemplary and not intended to be limiting. Furthermore, it is contemplated that production management system 140 may include alternative and/or additional components than those listed such as, for example, one or more software programs including instructions for executing process steps when executed by CPU 141.

CPU 141 may be one or more processors that execute instructions and process data to perform one or more processes consistent with certain disclosed embodiments. For instance, CPU 141 may execute software that enables production management system 140 to request and/or receive operational data from data collector 125 of work machines 120. CPU 141 may also execute software that stores collected operation data in storage device 143. In addition, CPU 141 may execute software that enables production management system 140 to analyze operation data collected from one or more work machines 120, modify one or more production aspects of the work machine (e.g., production schedule, product release date, production budget, etc.), improve a component parameter based on one or more predefined specifications associated with the component, and/or provides customized operation analysis reports, including recommendations for component optimization and/or design.

281 CPU 141 may be connected to a common information bus 146 that may be configured to provide a communication medium between one or more components associated with production management system 140. For example, common information bus 146 may include one or more components for communicating information to a plurality of devices. CPU 141 may execute sequences of computer program instructions stored in computer-readable medium devices such as, for example, a storage device 143, RAM 144, and/or ROM 145 to perform methods consistent with certain disclosed embodiments, as will be described below.

Communication interface 142 may include one or more elements configured for two-way data communication between production management system 140 and remote systems via transceiver device 126. For example, communication interface 142 may include one or more modulators, demodulators, multiplexers, demultiplexers, network communication devices, wireless devices, antennas, modems, or any other such devices configured to provide a two-way communication interface between production management system 140 and remote systems or components.

One or more computer-readable medium devices may include one or more storage devices 143, a RAM 144, ROM 145, and/or any other magnetic, electronic, or optical data computer-readable medium devices configured to store information, instructions, and/or program code used by CPU 141 of production management system 140. Storage devices 143 may include magnetic hard-drives, optical disc drives, floppy drives, or any other such information storing device. A random access memory (RAM) device 144 may include any dynamic storage device for storing information and instructions by CPU 141. RAM 144 also may be used for storing temporary variables or other intermediate information during execution of instructions to be executed by CPU 141. During operation, some or all portions of an operating system (not shown) may be loaded into RAM 144. In addition, a read only memory (ROM) device 145 may include any static storage device for storing information and instructions by CPU 141.

Production management system 140 may be coupled to on-board data collection and communication equipment to monitor, collect, and/or transmit information associated with an operation of one or more components of work machine 120. In one embodiment, production management system 140 may be coupled to one or more data collection devices 125 on respective work machines 120 via transceiver device 126 to collect operation data from one or more monitoring devices 121, such as sensors, electronic control modules, etc. (not shown), and/or any other such components for monitoring, collecting, and communicating information associated with the operation of a respective work machine 120. Production management system 140 may also be configured to transmit information to work machine 120 via communication network 130.

Production management system 140 may also include other components that perform functions consistent with certain disclosed embodiments. For instance, production management system 140 may include a memory device configured to store, among other things, one or more software applications including, for example, a database program, a graphical user interface, data acquisition and analysis software, or any other appropriate software applications for operating and/or monitoring production environment 100.

Production management system 140 may further include one or more components to analyze operational information from work machines 120 based on predefined specifications stored in storage device 143. For example, in addition to CPU 141, production management system 140 may be configured with on-board logic circuitry that analyzes operational data received from work machines 120. For the purposes of this disclosure, predefined specifications include one or more data indicative of an appropriate design or operation of a particular work machine 120, type of work machine 120, or its constituent components. For example, predefined specifications may include, for example, benchmark operational ranges, stress-strain thresholds, mechanical force limits, fuel economy, temperature ranges, pressure ranges, load limits, or any other such predefined specification benchmarking the performance of a work machine under test or during normal operations. Moreover, each of the predefined specifications may be associated with one or more components of work machine 120 such as, for example, a combustion engine, a motor, a transmission, a fluid cooling system, a generator, a cooling tank, a lubricating fluid, or any other component of work machine 120.

Production management system 140 may also be configured to compare the received operation data from a work machine 120 to one or more predefined specifications and/or determine whether the received operation data conforms to the predefined specifications. For example, production management system 140 may receive operation data from, among other things, an electric motor. The operation data may include data indicative of a field current through a stator winding of the motor. Production management system 140 may compare the received field current data to predefined specifications related to the field current of the motor. Production management system 140 may be configured to determine whether the received field current (i.e., actual field current during motor operation) conforms to the predefined specification data indicating an appropriate operational level for the field current. Although this example illustrates the received operation data as being associated with one component, it is contemplated that received operation data may include any data indicative of an operation of work machine 120 or any of its constituent components. Furthermore, production management system 140 may be configured to analyze operation data associated with any number of components of work machine 120, and may perform the analyses in series, parallel, simultaneously, sequentially, or any combination thereof.

Production management system 140 may be configured to identify one or more non-conforming components associated with the analysis of the received operation data. As in the above example, if the comparison of received operation data to the predefined specifications associated with the motor, production management system 140 may be identify the motor as a non-conforming component.

Production management system 140 may also be configured to determine a degree of non-conformance of the identified non-conforming components with respect the predefined specifications, provide an impact analysis of the non-conforming component on the operation of work machine 120, and adjust a production aspect of work machine 120 based on the impact analysis. For instance, as in the example above, production management system may identify a motor as a non-conforming component and determine a degree of non-conformance. The degree of non-conformance may include a percent deviation from the predefined specification, a value indicative of an relative statistical deviation, a degree of non-correlation of the non-conforming part, or any other such indicator for assigning a value corresponding to a degree with which a component deviates from a predefined specification.

In certain embodiments, an impact analysis of the non-conforming part may be generated by production management system 140. This impact analysis may include a list of non-conforming components of the work machine, an indication of the degree of non-conformance, and/or an impact of the non-conforming component on appropriate operation of work machine 120. The impact analysis may also include recommendations for modifying work machine or any of its components (particularly those that are non-conforming) to enhance the operation of work machine 120. The impact analysis may include design factors that may be modified, including one or more critical variables for correcting the non-conforming component. For the purposes of this disclosure a non-conforming component may include a hardware, software, or firmware component or data element included as part of work machine 120 that does not meet the predefined specifications prescribed for that component.

Production management system 140 may adjust a production aspect of work machine 120 based on the impact analysis. Thus, production management system 140 may request a standby of the production of a specific non-conforming component of work machine 120 based on the impact analysis of the non-conforming component. Furthermore, should re-design become necessary to correct the non-conforming component, production management system 140 may adjust the production schedule and/or product release date.

Production management system 140 may also be configured to improve one or more operational characteristics and/or specifications of non-conforming components. For example, CPU 141 may execute one or more software programs to analyze, test, debug, and/or simulate various aspects of a non-conforming component to determine which, if any, specification may be modified to correct the non-conforming component.

Production management system 140 may provide the improved results to the production entity 150 for additional analysis of the non-conforming component. Production management system 140 may provide recommendations and data reports summarizing the optimization results produced during the execution of the software program.

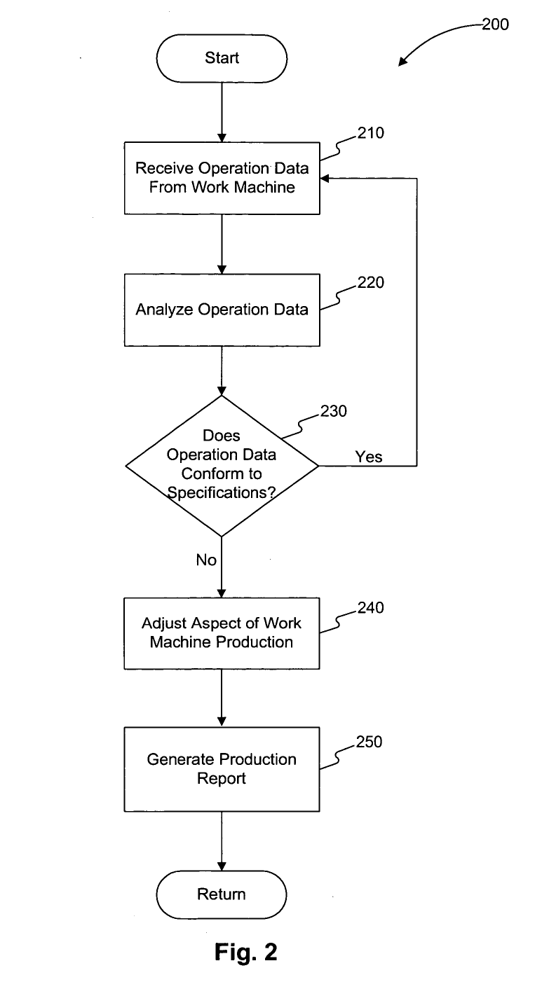

As explained, systems and methods consistent with certain disclosed embodiments provide an environment that allows modification of production and manufacturing processes based on “real-time” operation data from on or more work machines 120. FIG. 2 shows a flowchart 200 that illustrates an exemplary disclosed method for modifying a production aspect of work machine 120. As illustrated in FIG. 2, operation data may be received by production management system 140 from one or more work machines 120 (Step 210). For example, production management system 140 may receive operation data from one or more work machines from data collector 125 coupled to one or more monitoring devices 121. Production management system 140 may store the received operation data for future access and analysis.

Production management system 140 may analyze the received operation data (Step 220) with respect to one or more predefined specifications stored in a computer-readable medium. Predefined specifications may include one or more user defined criteria on which the design and operation of work machine 120 was based. Predefined specifications may include safety specifications, emission specifications, system health requirements, operation characteristics, design requirements, or any other benchmark for establishing appropriate operation of work machine 120 or any of its constituent components.

Upon analysis of the received operation data, production management system 140 may determine that the operation data conforms to the predefined specifications (Step 230; Yes) indicating that the operation of work machine 120 and the monitored components thereof may be normal. Alternatively, should the received operation data not conform to the predefined specifications (Step 230; No), thereby indicating that one or more components of work machine 120 may not conform the predefined specification and/or may be operating abnormally, one or more production aspects of work machine 120 may be modified (Step 240). For example, if a certain component is determined to be non-conforming, production management system 140 may generate a message that is issued to production facility 160 recommending that the production of work machine 120 should be temporarily halted, allowing for additional analysis by one or more production entities 150.

Upon adjusting the one or more production aspects of work machine 120, a production report may be provided to production entity 150 and/or production facility 160 (Step 250). In one exemplary embodiment, the production report may include the status of one or more components of work machine 120, including any non-conforming components. Recommendations may also be provided in the production report, suggesting possible actions, including design changes, optimizations, and/or other activities that may increase the production efficiency or result in time/cost savings in subsequent re-design and/or testing efforts.

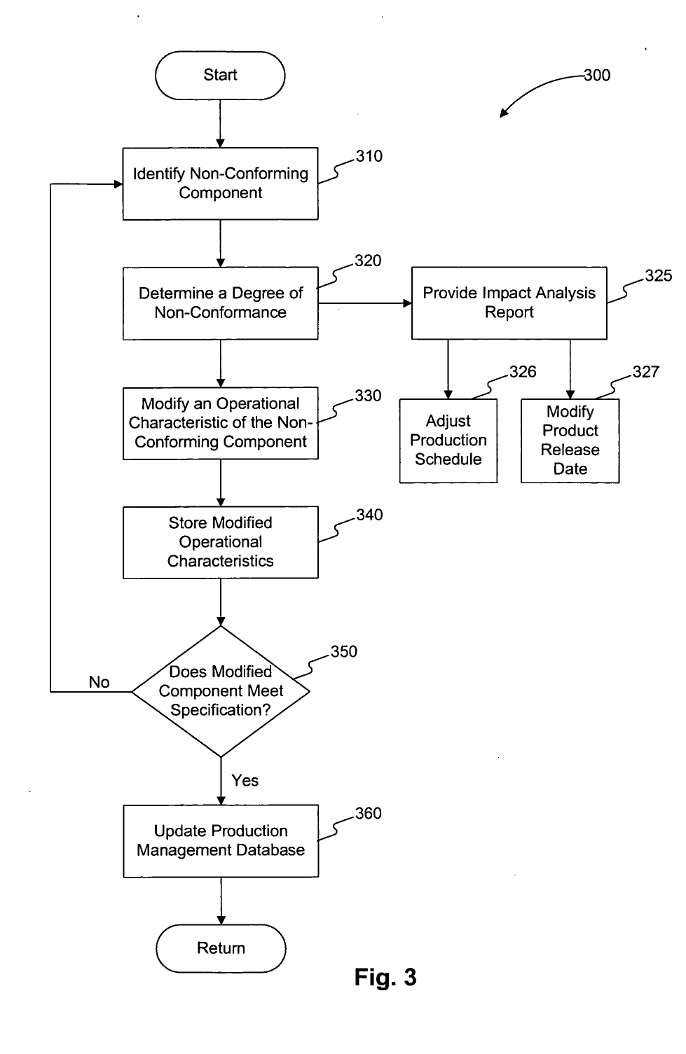

As previously described, methods and systems consistent with the disclosed embodiment enable production management system 140 and/or production entity 150 to improve the production of work machine 120 based on “real-time” operation data received from work machine 120. FIG. 3 illustrates a flowchart 300 depicting an exemplary disclosed method for improving the production of a work machine and its constituent components. Operation data may be received from work machine 120 by production management system 140 and analyzed to identify one or more non-conforming components based on a comparison of the received operation data and one or more predefined specifications (Step 310).

Upon identification of non-conforming components, a degree of non-conformance may be determined using statistical methods for calculating deviation of component data (Step 320). For example, one or more statistical software models may be stored in storage device 143 and executed by CPU 141 to determine a degree of non-conformance of the component according to any of a variety of statistical methods known in the art.

An impact analysis report may be provided based on the determined degree of non-conformance (Step 325), which may include recommendations for modifications to one or more of the non-conforming components (not shown), adjustments to the production schedule (Step 326), and/or modification of the product release date (Step 327). The impact analysis report may be provided to production entity 150 and/or production facility 160 for further external analysis, design, and testing.

Once the degree of non-conformance of the component has been established, production management system 140 may modify an operational characteristic of the non-conforming component based on one or more requests from production entity 150 (Step 330). For example, production entity 150 may re-design the non-conforming component and upload the modified component characteristics to production management system 140 for distribution to production facility 160, which updates the manufacturing specifications according to the re-design. Alternatively and/or additionally, should any software or firmware updates be required as a result of the modified component characteristics, production management system 140 may upload the modified software or firmware code to work machine 120 via communication network 130. Also, the modified software and firmware code may be sent to production facility 160 to modify any software/firmware that is being produced and/or installed in work machine under production.

Modified operation characteristics may be stored in storage device 143 (Step 340) for future access by production management system 140, production entity 150, and/or production facility 160. For example, production management system 140 may store the modified operation data for use as historical reference data during future optimization sessions, in impact analysis reports to compare differing results for subsequent non-conforming component test operations, or in cost analysis to determine financial impact and/or cost savings associated with production management system 140.

The modified component may be re-tested (i.e., operated in production environment 100) to determine if work machine 120 (and modification of the non-conforming component) meets the predetermined specifications (Step 350). Should operation of the work machine fail to conform to the predefined specifications (Step 350; No), the process may be re-started in order determine which components need further design.

Alternatively, should operation of work machine with the modified component conform to the predefined specifications (Step 350; Yes), production management system 140 may update project management database to reflect the update of specifications of the modified component and information tracking the status of work machine 120 (e.g., the machine is operating within threshold limits etc.) (Step 360). In one exemplary embodiment, the production schedule and/or the product release date may be updated to reflect the conformance of the updated characteristics to the predefined specifications. Furthermore, additional analysis reporting may be supplied to production entity 150 and/or production facility 160 to reflect the updated operational characteristics and recommendations to further enhance production and design capabilities.

### INDUSTRIAL APPLICABILITY

Methods and systems consistent with the disclosed embodiments enable the “real-time” adjustment of the production and manufacturing of work machines and their constituent components based on operation data gathered from one or more monitored work machines. Production environments that employ processes and elements consistent with certain disclosed embodiments allow for a user or software process to supply one or more predefined specifications to a production management system which subsequently analyzes received operation data based one the predefined specifications. Additionally, certain embodiments enable the production management system to identify, improve, analyze, and update operational characteristics of non-conforming components and report analysis data to other systems associated with the production of a work machine.

Although the disclosed embodiments are directed to a production environment associated with work machine 120, the disclosed system and method for improving the production of a work machine may be applicable to any environment where it may be desirable to modify the production of a work machine based on operation data received from test models in the “real-time.” Specifically, the disclosed system and method for improving the production of a work machine may collect and analyze operation data from one or more work machines 120 and adjust the production of the work machines according to the analysis.

The disclosed system for improving the production of a work machine enables a production management system 140 to collect operation data from one or more work machines 120 and modify the production of the work machines as the data is being received based on predefined specifications. Thus, time delays associated with updating production and manufacturing schedules and/or other production aspects related to the manufacturing of work machines may be significantly reduced, as a user is no longer required to subjectively predict the delays associated with certain types of non-conforming conditions. Instead, production management system may be configured to automatically and objectively update production information based on the received operation data. As a result, embodiments associated with production management system 140 may reduce time delays and errors resulting from improper modification of production aspects of a work machine.

Furthermore, the disclosed embodiments associated with production management system 140 may decrease the costs associated with research, development, design, and testing of work machine 120. For example, because production management system 140 may employ remote data monitoring systems via communication network 130, field engineers and product developers may no longer be required to manually collect operation data in remote test sites (i.e., mine sites, oil platforms, farm sites, proving ground locations, etc.), thereby reducing the time and resource costs associated with intensive test operations.

Moreover, because production management system 140 may be integrated within a common communication network 130, “real-time” data may be accessible from a number of off-site locations simultaneously, providing a more integrated production network than conventional production management systems allow. For example, a plurality of the same type of work machine (e.g., track-type tractors) may be operated in different locations under differing operating conditions. A first work track-type tractor may be operated in mountainous terrain, while a second work machine may be operated in relatively flat terrain. Production management system 140 may collect data from the first and second work machines and analyze the data based on the separate operating environments to ensure that the components of the work machine may be designed to operate in a broad range of applications. As a result, production management systems consistent with certain disclosed embodiments may allow for remote data distribution between test and production facilities that may not be geographically proximal allowing greater flexibility than traditional production management systems.

In addition, personnel productiveness may be increased as production management system 140 may perform much of the preliminary analysis associated with non-conforming components including, for example, providing impact analysis of non-conforming components on the production aspects of work machine 120 and generating detailed reports that may include modification recommendations. As a result, because production management system 140 may be configured to perform these tasks automatically, design engineers may dedicate more of their time performing engineering tasks without having to unnecessarily invest time in preliminary data collection and analysis.

It will be apparent to those skilled in the art that various modifications and variations can be made to the disclosed system and method for improving the production of a work machine. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

1. A system for improving the production of a machine, comprising:
a data collector disposed within the machine and configured to collect operation data associated with the machine and transmit the collected data over a communication network;
a production management system, coupled to the communication network and configured to:
receive the operation data from the data collector,
analyze the received operation data based on one or more predefined specifications, and
adjust a production aspect of the machine if the received operation data does not conform to the one or more predefined specifications.

2. (canceled)

3. The system of claim 1, wherein the production management system is further configured to:
identify a first non-conforming component associated with the machine based on the non-conforming operation data;
modify an operational characteristic of the first non-conforming component; and
transmit data to the machine reflecting the modified operational characteristic, wherein the transmitted data adjusts an operation of the machine in accordance with the modified operational characteristic.

4. The system of claim 29, wherein the production management system is further configured to:
determine a degree of non-conformance of the received operation data with respect to the predefined specifications; and
provide, to the production entity, an impact analysis of the operation of the machine based on the degree of non-conformance of the received operation data.

5. The system of claim 4, wherein adjusting a production aspect of the machine further includes modifying a production schedule of at least one of the machine or a component of the machine, based on the impact analysis.

6. The system of claim 4, wherein adjusting a production aspect of the machine further includes modifying a product release date of at least one of the machine or a component of the machine, based on the impact analysis.

7. The system of claim 29, wherein the production management system is further configured to adjust a production aspect of the machine by:
improving an operational characteristic of a first non-conforming component of the machine, based on the one or more predefined specifications;
provide the improved characteristic to the production entity; and
provide, based on the improved operational characteristics, recommendations for redesigning the first non-conforming component to the production entity.

8. The system of claim 1, wherein the communication network includes a wireless communication network for remote data communication between the machine and the production management system.

9. A method for improving the production of a machine, comprising:
receiving, in a production management system, operation data associated with a first operation of the machine during operation of the machine;
analyzing the received operation data based on one or more predefined specifications;
adjusting a production aspect of the machine if the received operation data does not conform to the one or more predefined specifications; and
providing the adjusted production aspect to a production facility that manufactures at least one of the machine and a component of the machine.

10. The method of claim 9, wherein adjusting the production aspect includes:
identifying a first non-conforming component associated with the non-conforming operational parameters;
modifying an operational characteristic of the first non-conforming component; and
transmitting the modified operational characteristic to the first non-conforming component via a communication network.

11. The method of claim 10, wherein modifying an operational characteristic includes:
improving an operational characteristics of the first non-conforming components based on the one or more predefined specifications; and
providing, to the production facility, recommendations for modifying the first non-conforming component based on the improved operational characteristics.

12. The method of claim 10, wherein receiving operation data includes:
receiving operation data from a data collection device coupled to the machine; and
storing the received operation data in a storage device accessible by the production facility.

13. The method of claim 10, wherein adjusting a production aspect of the machine includes:
determining a degree of non-conformance of the received operation data with respect to the one or more predefined specifications; and
providing, to the production facility, an impact analysis of the first operation based on the degree of non-conformance of the received operation data.

14. The method of claim 13, wherein adjusting a production aspect of the machine further includes modifying a production schedule of at least one of the machine and a component of the machine based on the impact analysis.

15. The method of claim 13, wherein adjusting a production aspect of the machine further includes modifying a product release date of at least one of the machine and a component of the machine based on the impact analysis.

16. The method of claim 9, wherein the one or more predetermined specifications include operation data from a previous test operation of the machine stored in a storage device accessible by the production management system.

17. The method of claim 9, wherein the one or more predetermined specifications include a design tolerance supplied by the production facility.

18. A computer-readable medium storing instructions that, when executed by a processor, perform a method for improving production of a machine component, the method comprising:
receiving operation data associated with a current operation of a machine;
analyzing the received operational data to determine whether a machine component does not conform to a predefined design specification based on the received operation data; and
modifying a production aspect of the machine based on the analysis.

19. The computer-readable medium of claim 18, wherein the analyzing includes:
identifying a non-conforming component of the machine associated with the portion of the operation data that does not conform to the predefined design specifications; and
improving the non-conforming component based on the predefined design specifications.

20. The computer-readable medium of claim 19, wherein improving the non-conforming component includes:
adjusting an operational characteristic of the non-conforming component;
storing the adjusted operational characteristics of the non-conforming component in a storage device; and
providing the adjusted operational characteristics to a production entity associated with the machine.

21. The computer-readable medium of claim 20, further including instructions for:
calculating a degree of non-conformance of the received operation data with respect to the predefined design specifications; and
providing an impact analysis of the first operation based on the degree of non-conformance of the received operation data to a production entity associated with the machine.

22. The computer-readable medium of claim 20, wherein adjusting a production aspect of the machine further includes modifying a production schedule of the machine component based on the impact analysis.

23. The computer-readable medium of claim 20, wherein adjusting a production aspect of the machine further includes modifying a product release date of the machine component based on the impact analysis.

24. A production environment, including:
a first machine performing operations in a first machine environment;
a production management system configured to receive operation data from the first machine and including:
a computer-readable medium configured to store predefined specifications,
a processor, when executing program code on a memory device, configured to:
receive operation data associated with the operation of the first machine; and
modify a production aspect of the first machine if a portion of the operation data does not conform to the predefined design specification.

25. The production environment of claim 24, wherein modifying a production aspect of the first machine includes:
identify a non-conforming component of the machine associated with the portion of the operation data that does not conform to the to the predefined design specification; and
improve the non-conforming component, based on the predefined design specifications.

26. The production environment of claim 25, further including a production entity in communication with the production management system, wherein the production management system transmits the analyzed operation data to the production entity.

27. The production environment of claim 24, including:
a second machine performing operations in a second machine environment different from the first machine environment, wherein the second machine is the same type of machine as the first machine;
wherein the production management system is further configured to:
receive second operation data from the second machine, and wherein the processor is further configured to:
modify the production aspect of the first machine if at least one of a portion of the operation data and a portion of the second operation data does not conform to the predefined design specifications.

28. The production environment of claim 27, wherein the portion of the operation data and the portion of the second operation data includes the same parameter data for each of the first and second machines.

29. The system of claim 1, further including a production entity associated with the machine and in communication with the production management system, the production entity configured to:
receive the adjusted production aspect from the production management system; and
adjust a production of the machine in response to the adjusted production aspect.
